(19) United States
(12) Patent Application Publication
(10) Pub. No.: US 2026/0301378 A1
(43) Pub. Date: Oct. 1, 2026

(54) AUTOMATIC DATASET GENERATION FOR TRAINING COMPUTER VISION SYSTEMS AND APPLICATIONS

(71) Applicant: NVIDIA Corporation, Santa Clara, CA (US)

(72) Inventors: Ram Rangan, Chennai (IN); Deep Shekhar, Bangalore (IN); Ritesh Kumar, Bangalore (IN); Anjul Patney, Redmond, WA (US)

(21) Appl. No.: 19/091,436

(22) Filed: Mar. 26, 2025

(51) Int. Cl. G06V 10/774; G06V 10/26; G06V 10/74; G06V 10/764; G06V 30/10; G06V 30/413; G06V 30/42

(52) U.S. Cl. CPC G06V 10/774; G06V 10/26; G06V 10/761; G06V 10/764; G06V 30/10; G06V 30/413; G06V 30/42

(57) ABSTRACT

In various examples, datasets for training computer vision and/or other artificial intelligence (AI) models may be automatically generated using AI-based techniques. For instance, the systems and methods of the present disclosure may crawl network resources (e.g., webpages) that include information associated with an interactive application (e.g., a wiki page for a gaming application) to obtain “seed” images depicting objects from the interactive application, as well as information (e.g., metadata) corresponding to the seed images. In some examples, a multimodal language model may be used to process the seed images and corresponding information. Based on the processing, the systems and methods may assign one or more labels to the seed images. The labeled seed images may then be used to expand the training dataset by processing and identifying additional images that depict similar objects to those in the labeled seed images.

### BACKGROUND

Computer vision (CV) and other artificial intelligence (AI) models may be utilized in various applications for tasks such as object detection, object classification, and optical character recognition (OCR). For example, AI-powered virtual assistants may employ CV models to analyze images, enabling context-aware interactions based on detected objects, actions, and text. While advancements in foundational CV models may improve overall performance, task-specific fine-tuning may still be necessary to achieve the accuracy required for certain applications. This fine-tuning process may rely on well-labeled datasets, which can be important for training models to recognize domain-specific elements effectively.

However, the creation of such labeled datasets may often involve manual annotation by domain experts, a process that may be time-consuming, costly, and difficult to scale. Additionally, manual labeling may be susceptible to errors and inconsistencies, which could impact model performance. While semi-supervised learning (SSL) and other automated techniques may help mitigate some of these challenges, conventional approaches may often rely on clustering-based labeling methods that may not always provide the precision needed for application-specific datasets. Furthermore, existing labeling techniques may not adequately address the diverse requirements of complex environments, such as distinguishing between dynamic objects, static icons, and text-based elements.

### SUMMARY

Embodiments of the present disclosure relate to automatic dataset generation for training computer vision systems and applications. Systems and methods are disclosed that may automatically generate datasets (e.g., labeled images) for training computer vision and/or other artificial intelligence (AI) models. For instance, the systems and methods of the present disclosure may crawl network resources (e.g., webpages, databases, etc.) that include information associated with an interactive application (e.g., a wiki page for a gaming application) to obtain “seed” images depicting objects (e.g., characters, animals, landmarks, icons, etc.) from the interactive application (e.g., video game, educational application, augmented reality application, virtual reality application, etc.), as well as information corresponding to the seed images. As described herein, in some examples, the information may include metadata (e.g., alt text) associated with the seed images and indicative of what the seed images depict. In some examples, a multimodal language model may be used to process the seed images and corresponding information and, based on the processing, assign one or more labels to the seed images. The labeled seed images may be used to expand the training dataset by processing and identifying additional images that depict similar objects to those in the labeled seed images. For instance, a plurality of target images depicting various objects may be compared to the objects in the seed images, and a subset of the target images that depict objects matching the objects depicted in the seed images may be added to the training dataset.

In contrast to conventional systems, the systems of the present disclosure, in some embodiments, may leverage multimodal AI models (e.g., multimodal large language models) to automatically generate labeled seed images, which may then be utilized to create extensive training datasets by processing and slicing images from videos (e.g., gameplay videos) associated with an interactive application (e.g., video game). By integrating metadata from application websites and applying multimodal AI models for precise label assignment, the disclosed systems may eliminate the need for manual annotation of any type of seed datasets (e.g., image-based, video-based, audio-based, or any other type of seed datasets), reducing human effort while improving accuracy and scalability. Furthermore, the labeled seed images may serve as a foundation for identifying and labeling additional images extracted from application images and/or footage, ensuring that the generated datasets accurately capture objects, icons, and text elements in their native application environments. Additionally, in contrast to conventional systems, the systems of the present disclosure may arrange labeled seed images—corresponding to small, static icons—into grid-based patterns over varied application backgrounds, enhancing dataset diversity and improving recognition accuracy. This combination of automated seed labeling, large-scale dataset expansion, and structured augmentation techniques may enable the systems of the present disclosure to efficiently fine-tune AI-powered computer vision models with minimal human intervention.

### BRIEF DESCRIPTION OF THE DRAWINGS

The present systems and methods for automatic dataset generation for training computer visions systems and applications are described in detail below with reference to the attached drawing figures, wherein:

FIG. 1 is a data flow diagram illustrating an example of a process for automatically generating a training dataset for a computer vision model, in accordance with some embodiments of the present disclosure;

FIG. 2 illustrates an example of generating one or more training datasets using one or more labeled seed images and one or more target images, in accordance with some embodiments of the present disclosure;

FIG. 3A illustrates an example of a labeled image depicting an object, in accordance with some embodiments of the present disclosure;

FIG. 3B illustrates an example of a labeled image depicting multiple objects and including multiple labels, in accordance with some embodiments of the present disclosure;

FIGS. 4A-4C illustrate examples of images from a training dataset that include multiple labeled images arranged in a grid pattern, in accordance with some embodiments of the present disclosure;

FIG. 5 is a data flow diagram illustrating an example of a process for training one or more models using one or more training datasets, in accordance with some embodiments of the present disclosure;

FIG. 6 illustrates an example of a system that may perform one or more of the processed described herein, in accordance with some embodiments of the present disclosure;

FIG. 7 is a flow diagram illustrating an example of a method for using a multimodal language model to automatically label seed images for generating a training dataset, in accordance with some embodiments of the present disclosure;

FIG. 8 is a flow diagram illustrating an example of a method for training one or more vision models to label objects in an interactive application using one or more automatically generated datasets, in accordance with some embodiments of the present disclosure;

FIG. 9A is a block diagram of an example generative language model system suitable for use in implementing at least some embodiments of the present disclosure;

FIG. 9B is a block diagram of an example generative language model that includes a transformer encoder-decoder suitable for use in implementing at least some embodiments of the present disclosure;

FIG. 9C is a block diagram of an example generative language model that includes a decoder-only transformer architecture suitable for use in implementing at least some embodiments of the present disclosure;

FIG. 10 is a block diagram of an example computing device suitable for use in implementing at least some embodiments of the present disclosure; and

FIG. 11 is a block diagram of an example data center suitable for use in implementing at least some embodiments of the present disclosure.

### DETAILED DESCRIPTION

Systems and methods are disclosed related to automatic dataset generation for training computer vision systems and applications. For instance, a system(s) may obtain one or more “seed” images depicting one or more objects from (e.g., included in) an interactive application, as well as information (e.g., metadata) associated with the seed image(s). Based at least on using one or more language models (e.g., multimodal language models) to process the seed image(s) and the corresponding information, the system(s) may associate one or more labels with the seed image(s). For instance, the label(s) may indicate what type or classification of object(s) is depicted in the seed image(s), what the seed image(s) depicts as a whole (e.g., a descriptive caption), or any other information associated with the seed image(s) and/or the object(s) depicted therein. In some examples, the system(s) may use the labeled seed image(s) to generate a training dataset for training a computer vision model(s) by comparing additional images that depict similar objects to the object(s) depicted in the labeled seed image(s).

As described herein, in some examples, the system(s) may obtain application-specific seed images based at least on crawling webpages (or any other internet assets and/or network resources, such as APIs, online services, databases, or any other digital content) associated with an application (e.g., an interactive application). For instance, the system(s) may analyze the webpages (e.g., analyze webpage code (e.g., HTML) corresponding to the webpages) to identify images associated with a specific interactive application, such as screenshots, promotional artwork, icons, or any other kinds of images. In some instances, the system(s) may extract information (e.g., metadata) related to the seed images, including alt text (e.g., HTML alt text), image filenames (e.g., HTML image_filename, data_image_name, etc.), surrounding text (e.g., webpage text in context with or referencing the image(s)), Uniform Resource Locators (URLs), HTML title attributes or any other kind of information to infer potential classifications of objects depicted in the seed images. In various examples, the webpages may be associated with the interactive application or otherwise include information related to the interactive application. For instance, if the interactive application is a gaming application, then the webpages may include wiki pages corresponding to a specific video game title.

To crawl the webpages and obtain the seed images and corresponding information, the system(s) may use or otherwise perform automated web scraping techniques to systematically navigate and extract relevant content from the target webpages. For example, the system(s) may employ web crawlers configured to traverse hyperlinks, parse webpage structures, and/or identify image elements based on predefined criteria. In some instances, the system(s) may analyze HTML attributes—such as <img> tags, alt text, title attributes, surrounding text, or any other attributes—to determine the relevance of an image to the interactive application and/or to the training of the computer vision model(s). Additionally, the system(s) may extract and process associated metadata, such as HTTP link descriptions, to enhance contextual understanding of the images.

While described herein that the system(s) may obtain the seed images from webpages and/or by web crawling, this is not intended to be limiting. For instance, in some examples, the system(s) may obtain the seed images and their corresponding information from any source or documentation, such as websites, offline PDFs, or any other formats. As one example, a manual or other documentation related to the application may be stored offline and the system(s) may analyze this documentation to extract the seed images and/or their corresponding information.

In some examples, the system(s) may associate labels with the obtained seed images based at least on the information corresponding to the seed images. For instance, the system(s) may use one or more models (e.g., one or more multimodal language models) to process the obtained seed images and their corresponding metadata. That is, the system(s) may use the model(s) to analyze visual features of the seed images alongside the textual information obtained from crawling the webpages to infer appropriate, application-specific labels for the seed images/objects depicted therein. As an example, a seed image depicting an object (e.g., a dinosaur) may have associated HTML alt text of “Parasaur,” and the model(s) may process the seed image and the alt text (and/or any other available information) to infer that the seed image depicts a Parasaur. The system(s) may then associate the seed image with a label indicating that the object depicted in the seed image is a Parasaur.

As described herein, the system(s) may, in some examples, use the labeled seed images to expand the training dataset to include additional, labeled images depicting similar objects to the objects depicted in the labeled seed images. That is, the system(s) may use the labeled seed images to serve as reference data for obtaining, identifying, and/or labeling additional images (also referred to herein as “target images”) that depict similar, application-specific objects, thereby facilitating the automatic generation of a well-annotated, application-specific training dataset. For instance, continuing the above example in which the labeled seed image depicts the Parasaur, the system(s) may compare the Parasaur in the labeled seed image with dinosaurs depicted in a plurality of target images to identify a subset of the target images that also depict Parasaurs. In other words, the system(s) may compare first physical attributes (e.g., shape, size, color, etc.) of the Parasaur depicted in the seed image with second physical attributes of the dinosaurs (or any other kinds of objects) depicted in the target images to determine the subset of the target images that also depict Parasaurs.

In some examples, the system(s) may obtain the target images from various sources associated with the application. For instance, if the application is a gaming application, the system(s) may extract images from gameplay videos, promotional content, developer-provided assets, and/or publicly available media. In some instances, such as if the application is a gaming application, the system(s) may process video recordings of gameplay sessions—such as pre-recorded footage, live-streamed content, or developer showcases—to slice image frames at specific intervals, ensuring a diverse and representative collection of target images. Additionally, the system(s) may obtain target images from in-application screenshots, user-generated content, and/or documentation pages that feature relevant visual elements of the application.

In various instances, the system(s) may use various computer vision techniques—such as image retrieval, template matching, or any other computer vision techniques—to identify visual similarities between objects depicted in the labeled seed images and objects depicted in the target images. For instance, the system(s) may employ deep learning-based feature extraction models (e.g., DINOv2) to generate embeddings for the labeled seed images and target images, allowing for efficient similarity comparison. In some instances, segmentation models (e.g., SAMv2) may be used to isolate distinct objects within target images, ensuring that the comparisons focus on individual objects rather than entire scenes. In this way, by segmenting objects within an image, the system(s) may potentially generate labeled target images that depict multiple objects having different labels (e.g., a labeled target image that depicts both a Parasaur and a Tyrannosaurus rex). That is, one or more (e.g., each) segments of a given target image may be matched against images from the labeled seed image dataset (e.g., using DINOv2 image retrieval and template matching).

In some examples, the system(s) may associate one or more labels with the target images based at least on the identified visual similarities between objects depicted in the labeled seed images and objects depicted in the target images. For instance, if a target image contains an object that closely matches a labeled seed image, the system(s) may assign the corresponding label to that object in the target image. In some instances, the system(s) may determine or compute similarity scores between compared images, which may be used to determine confidence levels for associating a label with a target image. For example, similarity scores generated by feature-matching techniques (e.g., embeddings produced by DINOv2) may determine the confidence level of a label assignment. If the similarity score exceeds a predefined threshold, the system(s) may automatically assign the label to the target image without human intervention, in some instances. For lower confidence matches, the system(s) may, in some instances, flag the target image for optional human review to verify or refine the assigned labels.

In some instances, the system(s) may segment target images into distinct, non-overlapping regions and evaluate one or more (e.g., each) segments separately. The system(s) may compare one or more (e.g., each) segmented regions against labeled seed images and assign the label of the seed image with the highest matching score to the corresponding segment. This process may be repeated for one or more (e.g., all) segments of a given target image, allowing multiple labels to be assigned within the same target image. Additionally, the system(s) may determine bounding box information for each labeled object within a target image, enabling more precise annotations. In some instances, if a target image contains multiple distinct objects, the system(s) may generate multiple labels with corresponding bounding boxes, ensuring a comprehensive and structured dataset for training computer vision models.

In some examples, the system(s) may enhance dataset diversity by applying data augmentation techniques to labeled target images and/or labeled seed images in the dataset. For instance, the system(s) may adjust brightness, contrast, rotation, and/or cropping to create variations of the labeled images, ensuring that the trained computer vision models generalize well across different scenarios. Additionally, for static icons or UI elements of an interactive application, the system(s) may generate synthetic datasets by overlaying labeled images of the icons/elements on various background textures extracted from application scenes.

In some instances, the system(s) may use optical character recognition (OCR) for text detection and labeling in the target images. For example, the system(s) may use various OCR models (e.g., easyOCR, etc.) to identify text elements within target images and generate labeled datasets for application-related fonts, UI text, and/or interactive elements. In some instances, the system(s) may provide an interactive interface to allow users to review and correct auto-labeled text data, ensuring high accuracy in the training dataset. The corrected text data may be stored alongside the original OCR-extracted text to enhance the adaptability of the OCR models for recognizing application-specific fonts and/or text styles.

In some examples, the labeled dataset generated by the system(s) may be stored in a structured format compatible with common computer vision training pipelines. For instance, the dataset may be saved in COCO JSON format, Pascal VOC XML, YOLO text annotation format, or any other structured format, allowing for seamless integration with state-of-the-art deep learning frameworks.

As described herein, in some examples, the system(s) may train one or more models (e.g., computer vision models, multimodal language models, etc.) using the labeled dataset that includes the labeled seed images and/or labeled target images. In some examples, the model(s) may be associated with a virtual assistant for the interactive application, and the model(s) may be trained to identify classifications of objects in the interactive application. For instance, in a video game application that includes dinosaurs, a user might ask the virtual assistant “what kind of dinosaurs are displayed on the screen right now?”, and the virtual assistant may use the trained model(s) to process the on-screen image(s) and determine classifications of the dinosaurs. For instance, if a Parasaur and a Brachiosaurus are displayed, the virtual assistant might respond by saying “the dinosaur on the left is a Parasaur, and the dinosaur on the right is a Brachiosaurus.” During training of the model(s), the system(s) may apply the images in the dataset as input to the model(s) and iteratively refine or update parameters of the model(s) until the model(s) produce the desired output that matches the labels of the training images.

Although many of the examples herein are described with respect to using language models, and specifically multimodal language models (MMLMs), this is not intended to be limiting. For example, and without limitation, any of the various model(s) described herein may include any type of machine learning or computer vision model, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-trained (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural radiance field (NeRF) models, Gaussian Splat models, models with encoder-only architectures, models with decoder-only architectures, models with encoder-decoder architectures, generative machine learning models, large language models (LLMs), small language models (SLMs), vision language models (VLMs), multi-modal language models (MMLMs), and/or other types of machine learning models.

In some examples, the model(s) described herein may be packaged as a microservice—such as an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the model(s) (e.g., that has been optimized for high performance inference), an inference runtime software to execute the model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the model(s). When replacing or updating, the software that performs the replacement/updating may maintain user configurations of the inference runtime software and enterprise management software.

While many of the examples described herein are with respect to automatically generating labels for seed images and target images of a dataset, this is not intended to be limiting. For instance, the disclosed systems and methods may be used to generate labels for any type of seed datasets, including seed datasets that include images, videos, audio recordings, or any other type of seed datasets. As an example, metadata and/or other information related to an audio recording may be used to automatically determine a label for the audio recording, and then the labeled audio data may be used to label one or more target audio recordings for inclusion in an audio dataset for training.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

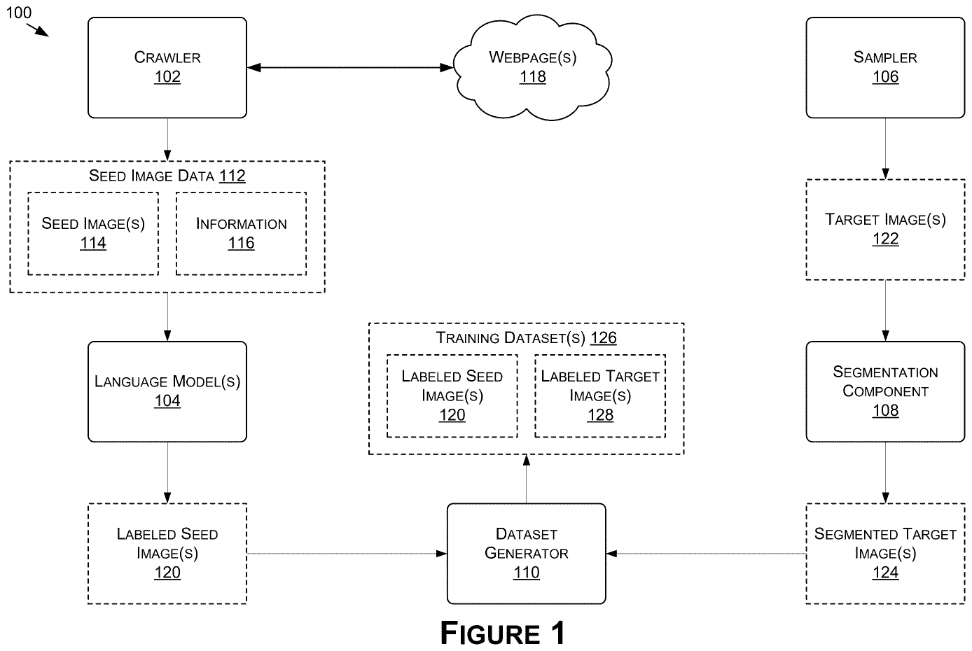

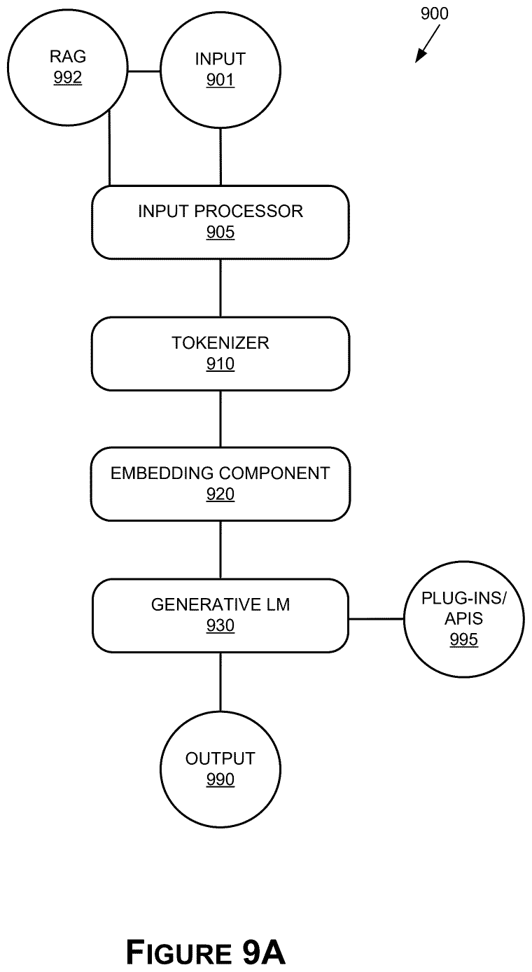

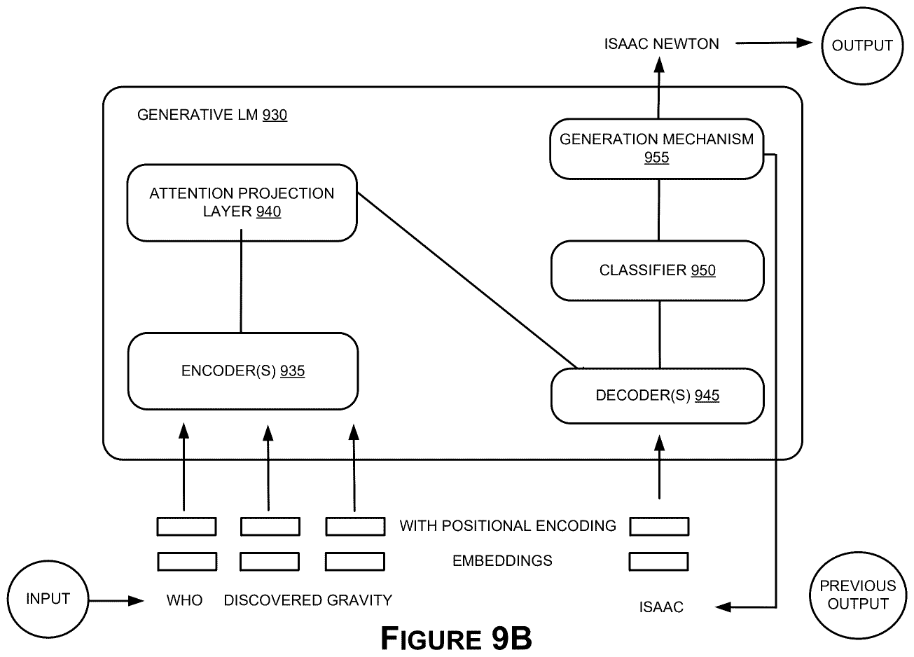

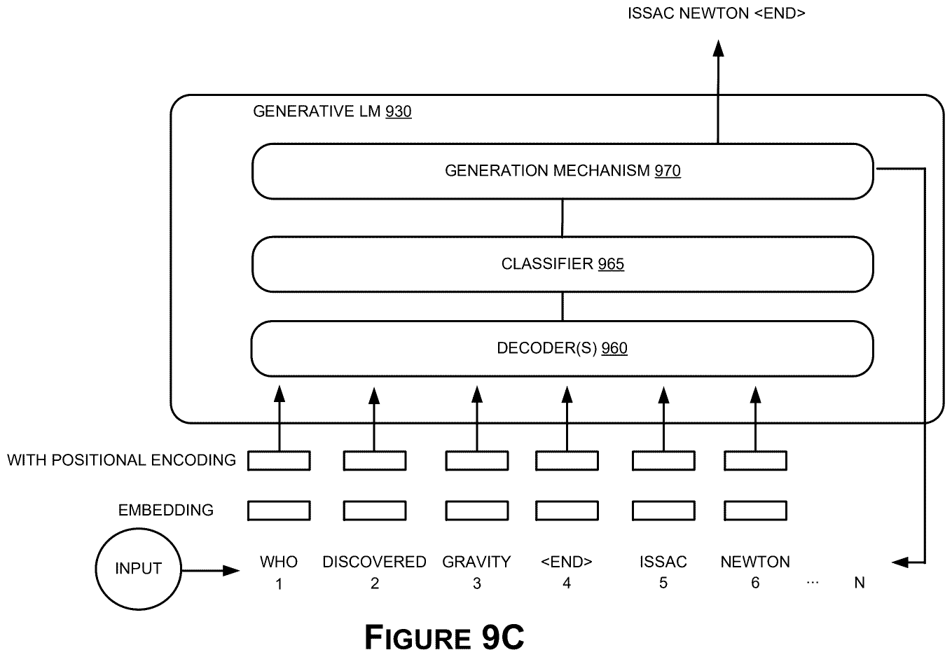

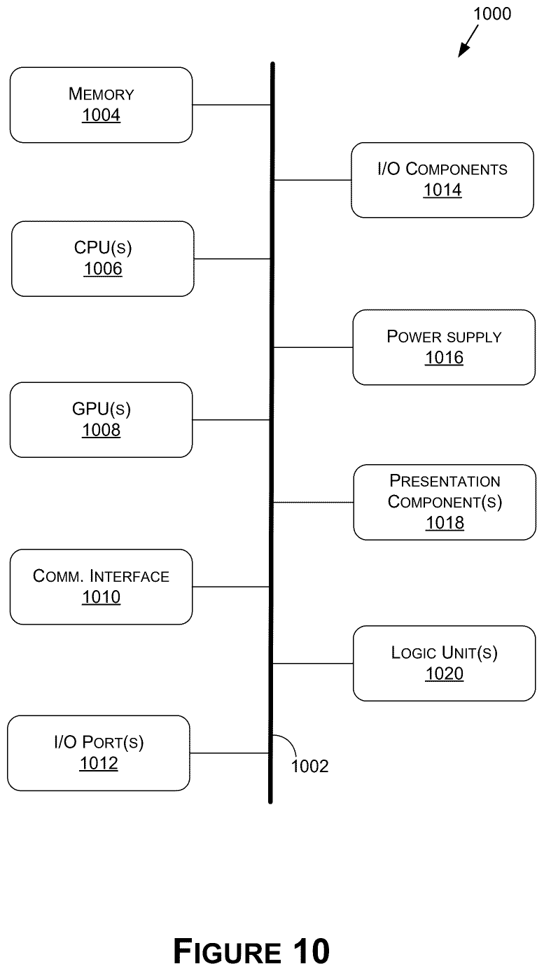

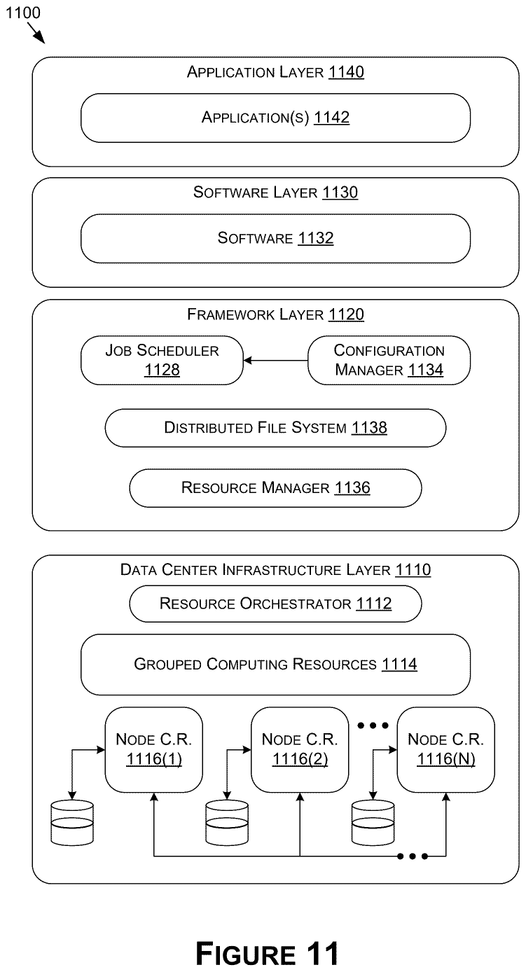

With reference to FIG. 1, FIG. 1 is a data flow diagram illustrating an example of a process 100 for automatically generating a training dataset for a computer vision model, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 9A-9C), one or more computing devices or components thereof (e.g., as described in FIG. 10), and/or one or more data centers or components thereof (e.g., as described in FIG. 11).

The process 100 may be implemented using, amongst one or more additional or alternative components, a crawler 102, one or more language models 104, a sampler 106, a segmentation component 108, and a dataset generator 110. As a brief overview, the process 100 may include the crawler 102 obtaining seed image data 112 (e.g., one or more seed images 114 and information 116) from one or more sources, such as webpage(s) 118. The seed image data 112 may be applied to the language model(s) 104 to generate one or more labeled seed images 120. The sampler 106 may obtain one or more target images 122 and apply the target image(s) 122 to the segmentation component 108. The segmentation component 108 may segment the target image(s) 122 to generate one or more segmented target images 124. The dataset generator 110 may use the labeled seed image(s) 120 and segmented target image(s) 124 to generate one or more training datasets 126, which may include the labeled seed image(s) 120 and one or more labeled target images 128.

In some examples, the crawler 102 may traverse the webpage(s) 118 to obtain the seed image data 112. In some examples, the webpage(s) 118 may be associated with an application (e.g., an interactive application, such as video game). For instance, the webpage(s) 118 may include one or more application-related wiki pages, webpages containing official promotional materials associated with the application, webpages containing application developer-provided assets, or any other kind of webpages. The crawler 102 may be configured to extract the seed image(s) 114 along with the information 116 from the webpage(s) 118 (e.g., from HTML files corresponding to the webpage(s) 118).

In some examples, the seed image(s) 114 may depict application-specific objects, such as in-application characters, locations, items, icons, menus, or user interface (UI) elements associated with the interactive application. For example, in a video game application, the seed image(s) 114 may include images of non-playable characters (NPCs), game environment elements (e.g., buildings, landscapes, etc.), inventory items (e.g., weapons, tools, etc.), or action indicators (e.g., ability icons, status effects, etc.).

In various examples, the information 116 may include metadata associated with the seed image(s) 114, such as alt text, filenames, surrounding webpage text, and/or hyperlink descriptions that reference the seed image(s) 114. As such, the information 116 may be indicative of what is depicted in the seed image(s) 114. For example, if a seed image 114 includes an NPC from a video game, the corresponding alt text might describe the NPC's name (e.g., “Parasaur NPC”), while the filename might include keywords related to the NPC's role or type (e.g., “Parasaur_mountable_character.png”). Similarly, surrounding webpage text could provide additional context, such as gameplay descriptions, lore details, or references to interactions within the game (e.g., “The Parasaur is a passive dinosaur that can be tamed and used as a scout in the game”). In some instances, hyperlink descriptions pointing to the seed image(s) 114 may further be indicative of the correct label to use for the depicted object, such as linking to a dedicated wiki page about the Parasaur NPC or an in-game item.

As shown, the process 100 may include the seed image data 112—including the seed image(s) 114 and the information 116—being applied as input to the language model(s) 104 (e.g., a multimodal large language model(s), a vision language model(s), etc.), and the language model(s) 104 generating the labeled seed image(s) 120 based at least on processing the seed image data 112. For example, the language model(s) 104 may analyze the visual content of the seed image(s) 114 while incorporating textual information from the information 116 (e.g., alt text, filenames, surrounding webpage text, and hyperlink descriptions) to infer the most appropriate label(s) for the seed image(s) 114. In some instances, the language model(s) 104 may include a multimodal language model(s) that uses multimodal processing to jointly evaluate the visual and textual data, enabling more accurate and context-aware labeling.

For instance, if a seed image 114 depicts a dinosaur, and the associated information 116 includes alt text stating “Parasaur,” a filename such as “herbivore_dino.png,” and a wiki hyperlink referencing the Parasaur's in-game behavior, the language model(s) 104 may process these inputs and generate a labeled seed image 120 with a label indicating that the depicted object is a “Parasaurolophus,” a “Parasaur,” and/or a “herbivore dinosaur.” Similarly, if the seed image 114 contains an in-application UI element such as a health bar, the language model(s) 104 may infer that the label should be “Health Bar—UI Element” based on associated metadata like “health_icon.png” and/or webpage text referencing “player health indicators.”

In some examples, the language model(s) 104 may rank potential labels for a seed image 114 based on a number of individual predictions based on the information available. For instance, if the seed image 114 depicts a labrador retriever and the desired label for the seed image is “labrador retriever” (e.g., as opposed to dog, canine, etc.), the language model(s) 104 may visually evaluate the seed image 114 and make a first prediction about what the image depicts, and assign a ranking or score to this first prediction. Additionally, the language model(s) 104 may analyze the information 116 corresponding to the seed image to make an additional prediction(s) about the object (or objects) depicted in the seed image 114. For instance, if the image filename is “labrador.jpg” the language model(s) 104 may make a second prediction about the object's label from this portion of the information. Additionally, or alternatively, if the alt text associated with the seed image 114 says “yellow lab” the language model(s) 104 may make a third prediction about the object's label from this portion of the information 116. Likewise, if the webpage includes surrounding text that says “labrador retrievers may come in a variety of colors, yellow, chocolate, and black, as well as potentially others” the language model(s) 104 may make a fourth prediction about the object's label and assign a score to this prediction. In some instances, the language model(s) 104 may come up with a final prediction about the label based on the individual confidences of each prediction.

In some examples, a statically assigned priority(ies) may be used to break ties between predictions with similar (e.g., very close, identical, etc.) confidence scores. For example, an image file name or alt text may have higher priority than the text surrounding the image and/or the model's predicted description/identification of the image. As such, if the seed image 114 depicts a Parasaur (Parasaurolophus) and the image file name is “parasaur.jpeg” but the surrounding text from the webpage says something like “the Tyrannosaurus Rex preys on various herbivore dinosaurs, such as Triceratops, Brachiosaurus, and, of course, the Parasaurolophus,” then the language model(s) 104 may prioritize the image file name over the surrounding text to determine that the seed image depicts a Parasaur.

The process 100 may also include the sampler 106 obtaining the target image(s) 122 that are to be compared to the labeled seed image(s) 120 to generate the training dataset(s) 126. For instance, the sampler 106 may obtain the target image(s) 122 by extracting images from various sources associated with the application, such as gameplay videos (or other application-related videos), developer-provided assets, user-generated screenshots, promotional content, and/or publicly available media. In some examples, if the application is a video game, the sampler 106 may process gameplay recordings, live-streamed content, and/or developer showcases to capture high-quality image frames that depict objects, characters, UI elements, and/or environmental features from the game.

In some instances, the sampler 106 may apply frame-slicing techniques to extract image frames at predefined intervals from application footage, ensuring that the obtained target image(s) 122 is representative of various application conditions, lighting scenarios, and/or perspectives. The sampler 106 may, in some examples, apply motion analysis techniques to prioritize frames where significant object movement, interactions, or UI changes occur, ensuring that the training dataset(s) 126 includes a diverse range of visual states. Additionally, or alternatively, the sampler 106 may filter and pre-process the extracted target image(s) 122 to ensure image quality and relevance. For example, low-resolution or blurry frames may be discarded, and images that contain incomplete or obstructed objects may be deprioritized. In some cases, the sampler 106 may also categorize the target image(s) 122 based on content type (e.g., NPCs, game environments, inventory items, UI elements, etc.) to facilitate more efficient labeling and dataset organization.

In some examples, the process 100 also includes the segmentation component 108 processing the target image(s) 122 to generate the segmented target image(s) 124. The segmentation component 108 may be configured to analyze and segment the target image(s) 122 into distinct, non-overlapping objects before being compared to the labeled seed image(s) 120. For instance, the segmentation component 108 may apply computer vision models—such as SAMv2 (Segment Anything Model) and/or other AI-based segmentation techniques—to isolate individual objects within one or more (e.g., each) of the target image(s) 122. The segmentation component 108 may use one or more of these models to detect object boundaries and/or generate segmentation masks, which may define the exact regions of one or more (e.g., each) objects within the target image(s) 122.

In some instances, the segmentation component 108 may refine the segmented target image(s) 124 by removing background noise, eliminating occlusions, and/or filtering out irrelevant image regions to ensure that only meaningful objects are processed. For example, if a target image 122 contains multiple game elements—such as a Parasaur, a UI health bar, and an inventory panel—the segmentation component 108 may separate each of these elements into independent segments so that they can be individually compared to the labeled seed image(s) 120. Additionally, in some instances, the segmentation component 108 may generate bounding box data and/or pixel-wise masks for each segmented object. This information may be stored along with the segmented target image(s) 124 to facilitate precise object labeling and improve the accuracy of the training dataset(s) 126.

The process 100 may also include the dataset generator 110 obtaining and using the labeled seed image(s) 120 and the segmented target image(s) 124 to generate the training dataset(s) 126. In some examples, the training dataset(s) 126 may include one or more of the labeled seed image(s) 120, the labeled target image(s) 128, and/or augmented/updated versions of one or more these images (not shown). The dataset generator 110 may process the segmented target image(s) 124 through an object labeling pipeline and/or an optical character recognition (OCR) labeling pipeline, ensuring that both visual objects and/or text-based elements are accurately labeled and incorporated into the final training dataset(s) 126.

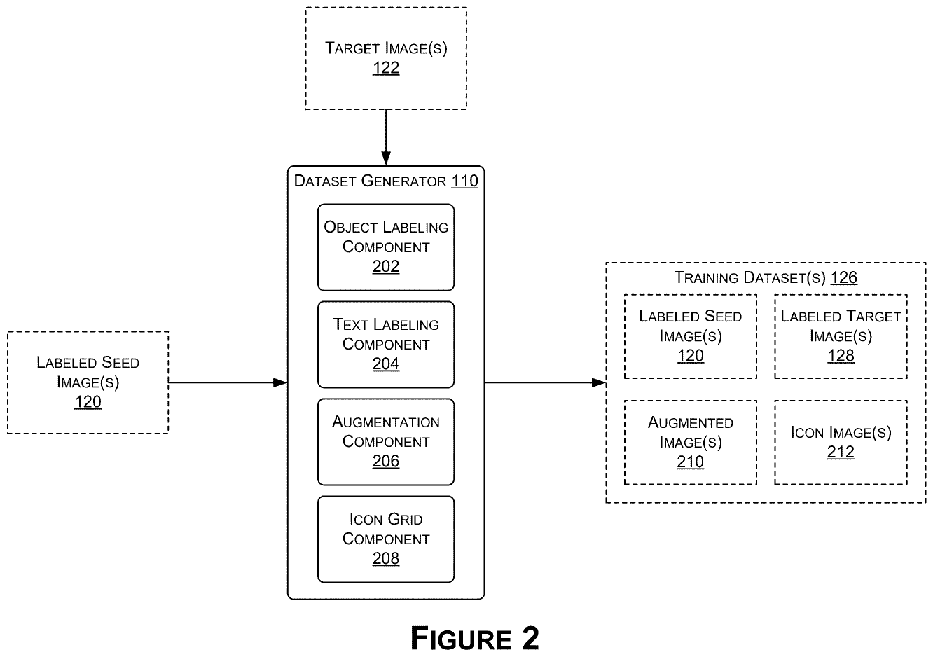

For instance, FIG. 2 illustrates an example of generating the training dataset(s) 126 using the labeled seed image(s) 120 and the target image(s) 122, in accordance with some embodiments of the present disclosure. Although illustrated in the example of FIG. 2 as applying the target image(s) 122 to the dataset generator 110, in additional or alternative examples, the segmented target image(s) 124 may be applied to the dataset generator 110 in addition to—or in the alternative of—the target image(s) 122. As illustrated in the example of FIG. 2, the dataset generator 110 may include an object labeling component 202, a text labeling component 204, an augmentation component 206, and an icon grid component 208.

In some examples, the object labeling component 202 may match one or more (e.g., each) objects depicted in the target image(s) 122 with one or more corresponding objects depicted in the labeled seed image(s) 120. For instance, the object labeling component 202 may use feature-matching techniques, such as embeddings generated using DINOv2, to compute similarity scores between objects in the target image(s) 122 and the objects in the labeled seed image(s) 120. If a similarity score meets or exceeds a predefined threshold, the object labeling component 202 may automatically assign the corresponding label to the object of the target image 122. In some instances, the object labeling component 202 may also assign bounding box data and/or segmentation masks to ensure precise object localization. Additionally, if multiple objects are present within a single target image, the object labeling component 202 may allow multiple, non-overlapping labels to be assigned to the different objects within the same target image.

The text labeling component 204 may, in some instances, process the target image(s) 122 (or the segmented target image(s) 124) to identify and extract text-based elements using optical character recognition (OCR) techniques. For example, the text labeling component 204 may apply OCR models (e.g., easyOCR or similar deep learning-based OCR frameworks) to detect and recognize in-application text, such as character names, ability descriptions, item labels, health indicators, UI elements, or other application-specific text. In some examples, the text labeling component 204 may analyze both printed and stylized text and generate text annotations that are stored alongside the corresponding labeled target image(s) 128 in the training dataset(s) 126. In some instances, the extracted text may be verified and corrected through an interactive user interface, allowing human reviewers to manually refine or correct the text labels. The corrected text may then be stored alongside the original OCR-extracted text, creating an improved dataset that can be used for fine-tuning OCR models to recognize application-specific fonts and/or text styles.

To further enhance dataset quality, the text labeling component 204 may generate bounding boxes or segmentation masks around detected text regions, ensuring precise localization of text elements within the labeled target image(s) 128. In some cases, the text labeling component 204 may also categorize extracted text into different groups (e.g., UI labels, dialogue text, numerical indicators) to help optimize training for text recognition models in different contexts. The final text-labeled images may be incorporated into the training dataset(s) 126 (e.g., as the labeled target image(s) 128, the augmented image(s) 210, etc.) to enable improved text detection and recognition in computer vision models.

To improve diversity and robustness of the training dataset(s) 126, the augmentation component 206 may apply data augmentation techniques, such as modifying brightness, contrast, rotation, and/or cropping, to enhance the variability of the labeled images (e.g., the labeled seed image(s) 120 and/or the labeled target image(s) 128). These augmented image(s) 210 may be included/stored as part of the training dataset(s) 126, as shown in FIG. 2. In some examples, the augmentation component 206 may also apply domain-specific augmentations to better reflect variations encountered within the interactive application. For instance, for in-game UI elements, the augmentation component 206 may overlay icons on different background textures to ensure that the trained models generalize across different visual contexts. Additionally, for OCR-labeled images, the augmentation component 206 may apply font distortions, noise injections, or perspective transformations to improve the robustness of text recognition models.

In some examples, the icon grid component 208 may be used to generate labeled datasets for static icons or UI elements that appear in grid-like patterns within an interactive application. For example, in a video game inventory system, ability hotbars, or settings menus, UI elements may be arranged in structured grids, making traditional segmentation approaches less effective. The icon grid component 208 may use template matching and/or positional analysis to identify individual icons, assign labels, and extract structured bounding boxes for each element. In some instances, the icon grid component 208 may apply heuristic-based processing to analyze spacing, alignment, and visual patterns in a grid-based interface to ensure accurate separation of icons.

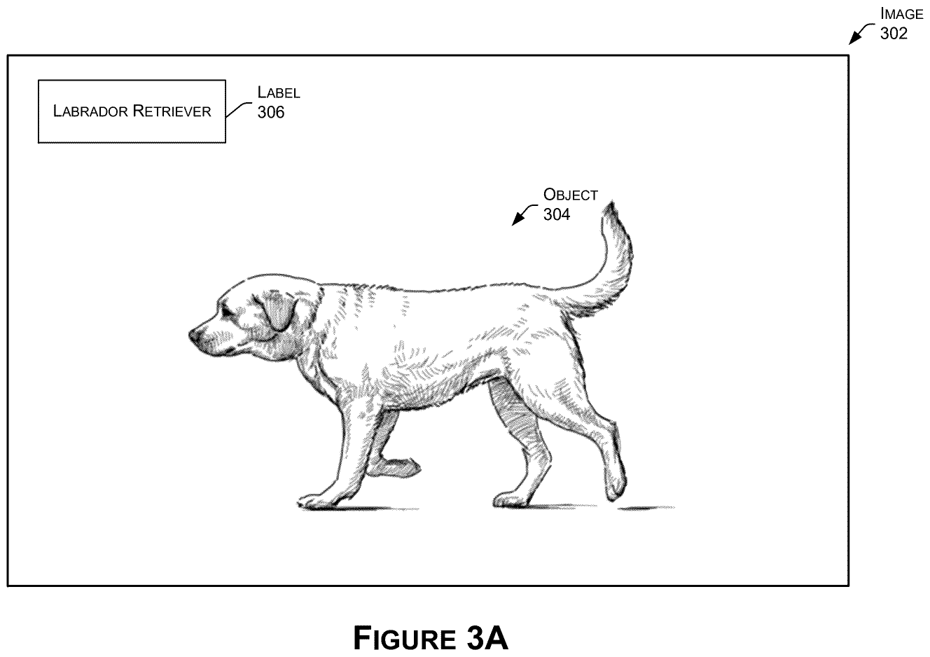

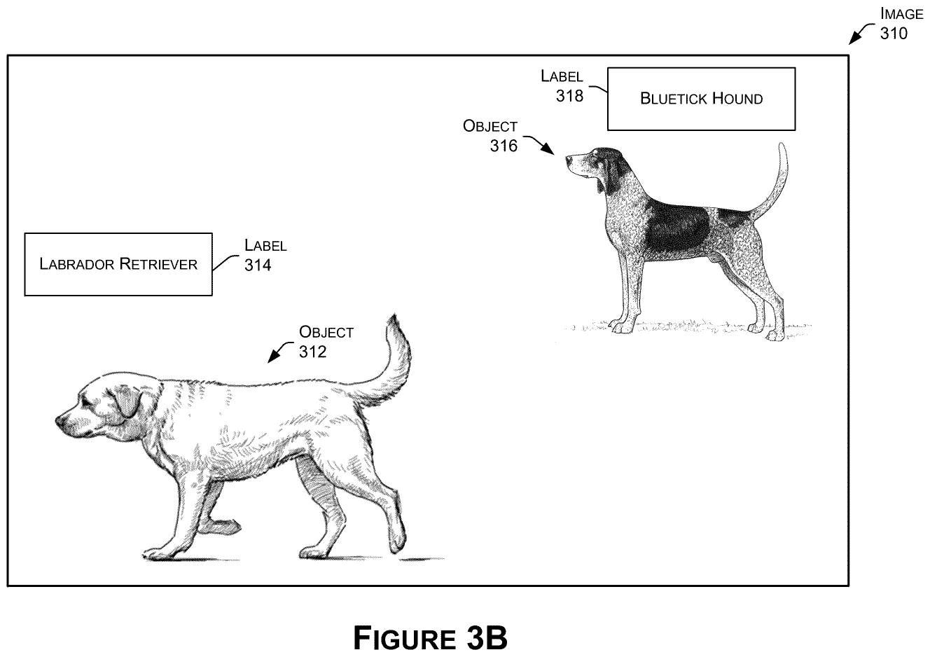

Referring now to FIG. 3A, FIG. 3A illustrates an example of a labeled image depicting an object, in accordance with some embodiments of the present disclosure. As shown, the image 302 depicts an object 304 and includes a label 306 indicating a classification of the object 304. For instance, the label 306 indicates that the object 304 is a labrador retriever. Additionally, or alternatively, the label 306 could indicate that the object 304 is a dog, a mammal, what color the dog is, or any other information based on the metadata obtained in association with the image 302. While this is just one example of associating a label 306 with an object 304 depicted in an image 302, in additional or alternative examples, the system(s) may associated any number of labels with any number of objects depicted in an image, and the labels (e.g., the label 306) may indicate any information related to the image.

For instance, FIG. 3B illustrates another example of a labeled image 310 depicting multiple objects and including multiple labels, in accordance with some embodiments of the present disclosure. As shown, the image 310 depicts a first object 312 and includes a first label 314 indicating a classification of the object 312. For instance, the first label 314 indicates that the first object 312 is a labrador retriever. The image 310 also depicts a second object 316 and includes a second label 318, which indicates that the second object 316 is a bluetick hound.

In some examples, image segmentation techniques may be used to ensure that each of the objects in the image 310 are individually detected and labeled. For instance, the systems of the present disclosure may use segmentation models such as SAMv2 (Segment Anything Model) and/or DINOv2 to identify and isolate distinct objects within the image 310. These models may analyze the image and generate segmentation masks, which may allow the systems to separate each object (e.g., the first object 312 and the second object 316) into non-overlapping regions.

Once segmented, each distinct object may be individually compared to labeled seed images using feature-matching techniques (e.g., embeddings produced by DINOv2). The dataset generator 110 may compute similarity scores between the segmented objects in the image 310 and reference objects from the labeled seed image(s) 120. If a match meets or exceeds a predefined similarity threshold, the corresponding label (e.g., “Labrador Retriever” for the first object 312, “Bluetick Hound” for the second object 316) may be automatically assigned. In some instances, if an object has multiple possible matches in the labeled seed dataset, the system(s) may prioritize the label associated with the seed image that has the highest similarity score. If the similarity score falls below a confidence threshold, the system(s) may flag the object for optional human review, allowing for manual verification and refinement of the assigned labels. For instance, a user (e.g., human reviewer) may look at the object and speak out the correct label, and the system(s) may use Eye-Tracking and/or ASR to assign the correct label to the correct objects within the image.

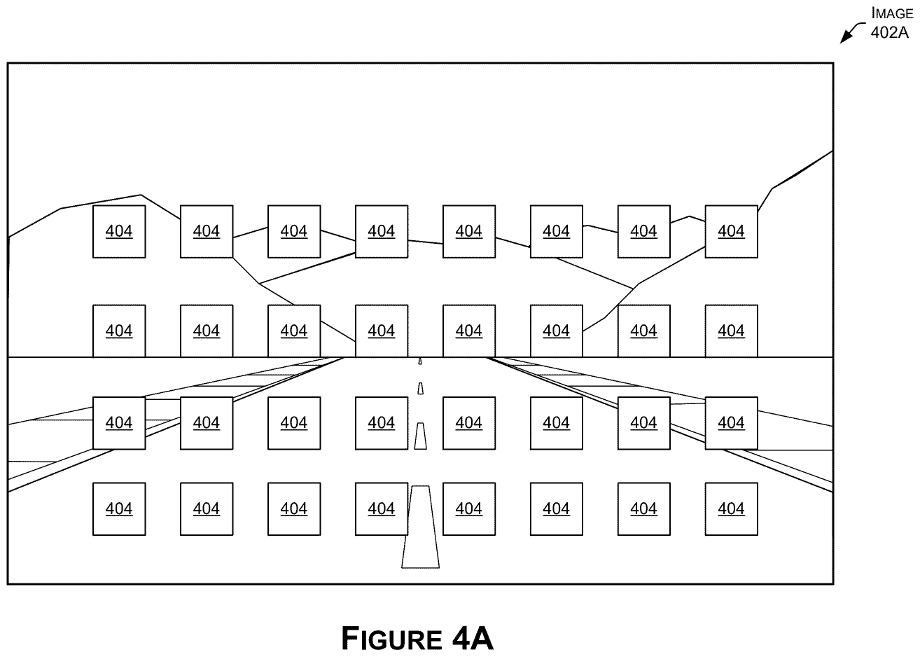

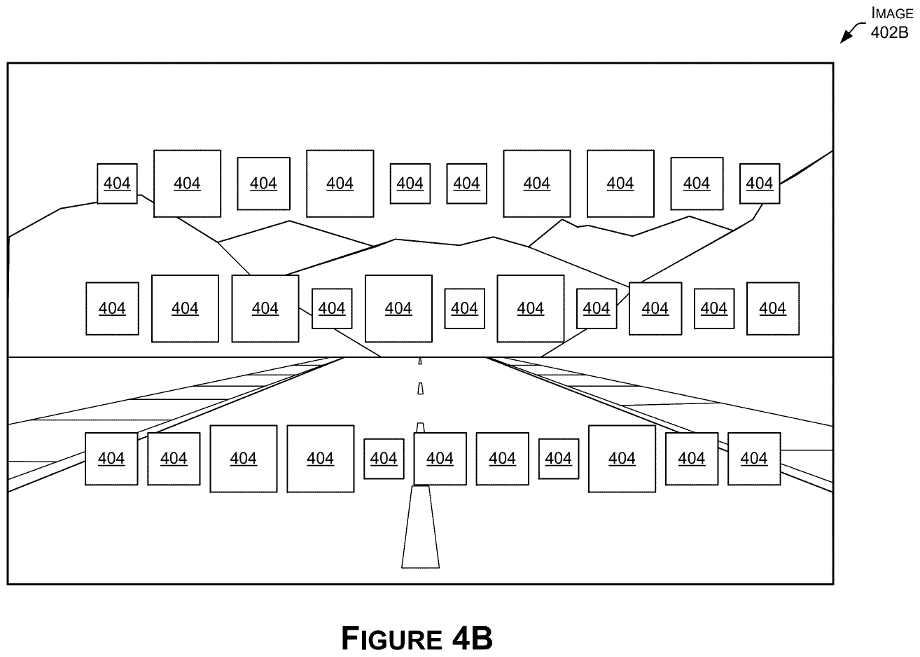

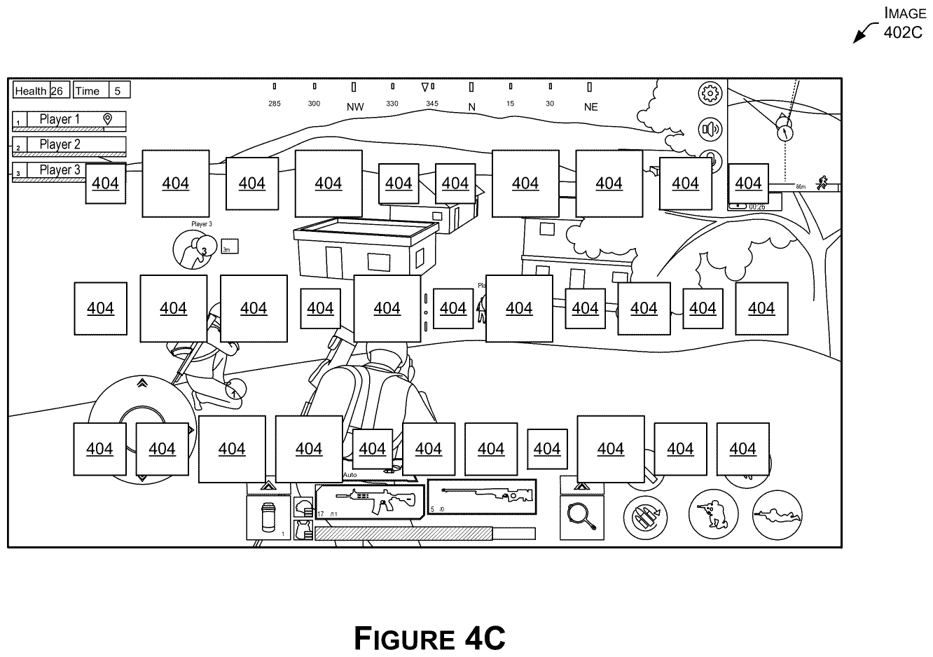

Referring now to FIGS. 4A-4C, FIGS. 4A-4C illustrate examples of images from a training dataset that include multiple labeled images arranged in a grid pattern, in accordance with some embodiments of the present disclosure. For instance, in some examples, the images 402A-402C in FIGS. 4A-4C may depict application-specific backgrounds/environments that are overlaid with a plurality of labeled images 404, which may correspond to application-specific icons, UI elements, and/or other static graphical components that are commonly arranged in a grid-based format within the interactive application. Such icons may include inventory items, ability icons, HUD elements, and/or menu selections from a video game or other software application. By structuring the labeled images 404 in a grid pattern as shown in FIGS. 4A-4C, the system(s) may efficiently increase dataset diversity while ensuring that static UI components are contextually represented across various backgrounds and application (e.g., gameplay) conditions.

Referring first to FIG. 4A, the image 402A includes the plurality of labeled images 404 arranged in a grid pattern and overlaid on a first application background. Although FIG. 4A includes the labeled images 404 arranged in an 8×4 grid, this is just an example and the systems of the present disclosure may arrange the labeled images 404 in any dimension of grid and/or in any order or position within the image. For instance, the labeled images 404 may be overlaid at any location within the image 402A. In some examples, the systems may overlay the labeled images 404 at locations within the image frame that correspond to actual locations the icons/UI elements may appear in the application. For instance, if the icons/UI elements are typically located in the upper-right corner of the image frame, the system(s) may cause the labeled images 404 to be overlaid near those locations. Additionally, in some examples, the labeled images 404 may be overlaid at random locations within the image frame. In some examples, the labeled images 404 may be different shapes and/or sizes. For instance, FIG. 4B includes the image 402B with the plurality of labeled images 404 arranged in a grid-like pattern and overlaid on the first application background, but with the labeled images 404 having different shapes and sizes.

As described herein, these grid-like patterns of the labeled images 404 may be overlaid on different application backgrounds to generate a robust and diverse dataset to train the computer vision models to identify static application icons/UI elements at any point in the application. For instance, FIG. 4C includes the image 402C with the plurality of labeled images 404 arranged in a grid-like pattern and overlaid on a second application background that is different from the first application background in the examples of FIGS. 4A and 4B. In various examples, the system(s) may arrange the labeled images 404 in the grid patterns over varied background textures extracted from application footage to help train computer vision models to recognize icons and UI components in different lighting conditions, screen resolutions, and/or overlay settings.

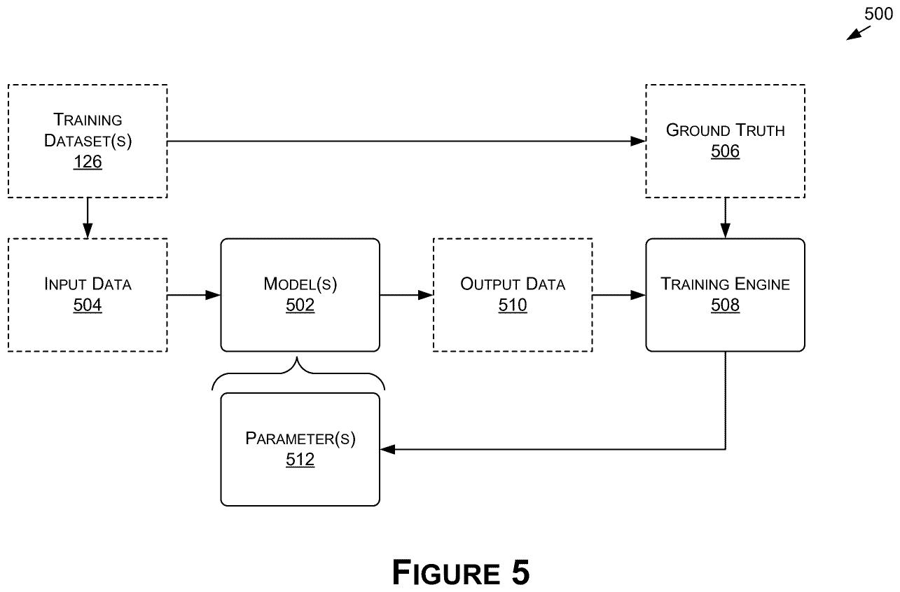

Referring now to FIG. 5, FIG. 5 is a data flow diagram illustrating an example of a process 500 for training one or more models 502 using the training dataset(s) 126, in accordance with some embodiments of the present disclosure. As shown, the model(s) 502 (e.g., computer vision model(s), multimodal language model(s), vision language model(s), etc.) may be trained using input data 504 (e.g., training data). The input data 504 may include or correspond to one or more of the images included in the training dataset(s) 126, such as the labeled seed image(s) 120 and/or the labeled target image(s) 128 (or unlabeled versions of these images).

The model(s) 502 may be trained using the training input data 504 as well as corresponding ground truth data 506 (which may correspond to the input data 504). The ground truth data 506 may, in some examples, include or correspond to the labeled images and/or the labels for the images included in the training dataset(s) 126. In other words, the input data 504 may include, at least, an image depicting an object(s), and the ground truth data 506 may include, at least, a label(s) indicating a classification(s) of the object(s) and/or any other information related to the image. In some examples, the ground truth data 506 may include annotations, labels, masks, and/or the like. For example, in some embodiments, the ground truth data 506 may indicate actual classification(s) associated with the object(s) within the image data.

A training engine 508 may use one or more loss functions that measure loss (e.g., error) in output data 510 generated by the model(s) 502 as compared to the ground truth data 506 and/or the input data 504. In some examples, the training engine 508 may compare the output data 510 (e.g., a predicted label associated with an object) from the model(s) 502 to the ground truth data 506 (e.g., actual label associated with the object), and optimize (e.g., update) the model(s) 502 based at least on the comparing. That is, the training engine 508 may update/optimize one or more parameters 512 associated with the model(s) 502 to reduce the losses/differences between the output data 510 and the ground truth data 506. Any type of loss function may be used, such as cross entropy loss, mean squared error, mean absolute error, mean bias error, and/or other loss function types. In some examples, different outputs may have different loss functions. In such examples, the loss functions may be combined to form a total loss, and the total loss may be used to train (e.g., update the parameter(s) 512 of) the model(s) 502.

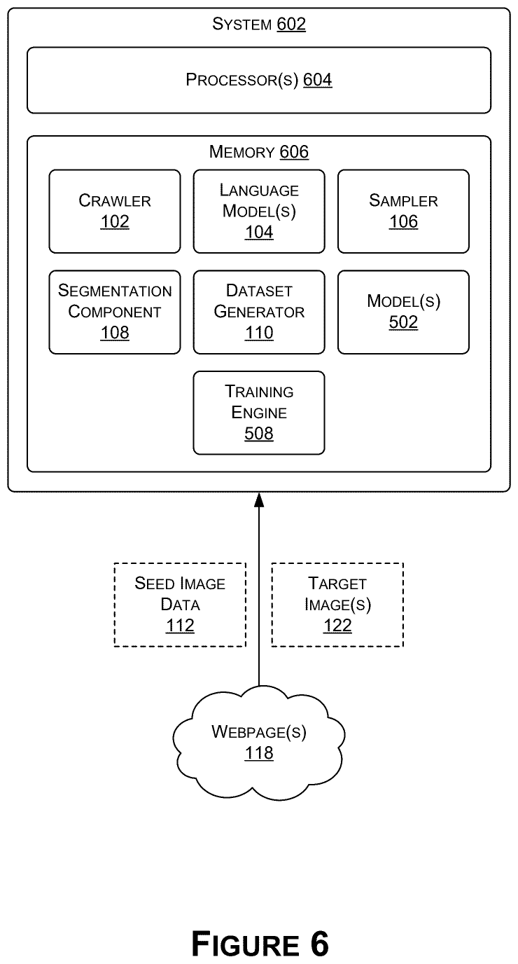

FIG. 6 illustrates an example of a system that may perform one or more of the processed described herein, in accordance with some embodiments of the present disclosure. As shown, the system 602 (which may represent, and/or include, the example computing device(s) 1000 and/or the example data center 1100) may include one or more processors 604 (which may be similar to, and/or include, the CPUs 1006 and/or the GPUs 1008) and memory 606 (which may be similar to, and/or include, the memory 1004). For instance, the memory 606 may store one or more of the crawler 102, the language model(s) 104, the sampler 106, the segmentation component 108, the dataset generator 110, the model(s) 502, and/or the training engine 508. Additionally, the processor(s) 604 may execute one or more of the crawler 102, the language model(s) 104, the sampler 106, the segmentation component 108, the dataset generator 110, the model(s) 502, and/or the training engine 508 to perform one or more of the processes described herein.

For instance, the system 602 may obtain the seed image data 112 and/or the target image(s) 122 from the webpage(s) 118 (or any other source, such as an image database, application-related videos, etc.). The seed image data 112 may be processed using the language model(s) 104 to generate labeled seed images, while the target image(s) 122 may be segmented into segmented target images using the segmentation component 108. These images may then be processed by the dataset generator 110, which may apply object labeling and text labeling techniques to assign labels and generate a structured training dataset(s) for training. The training dataset(s) may include labeled seed images, labeled target images, and augmented versions of these images, ensuring a diverse and well-annotated dataset. The training engine 508 may use the training dataset(s) to train the model(s) 502, including computer vision models, multimodal models, and/or optical character recognition (OCR) models.

Once trained, the model(s) 502 may, in some examples, be deployed as an inference microservice, allowing real-time classification of objects and text within an interactive application. For instance, in a gaming assistant scenario, a user may ask, “What items are in my inventory?”, and the trained model(s) 502 may analyze on-screen UI elements to generate a response. Similarly, for OCR-based applications, the model(s) 502 may detect in-game text, quest descriptions, or status indicators to improve accessibility and automation.

Although many of the examples herein are described with respect to using language models and computer vision models, this is not intended to be limiting. For example, and without limitation, any of the various model(s) described herein may include any type of machine learning or computer vision model, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-trained (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural radiance field (NeRF) models, Gaussian Splat models, models with encoder-only architectures, models with decoder-only architectures, models with encoder-decoder architectures, generative machine learning models, large language models (LLMs), small language models (SLMs), vision language models (VLMs), multi-modal language models (MMLMs), and/or other types of machine learning models.

In some examples, the model(s) described herein may be packaged as a microservice—such as an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the model(s) (e.g., that has been optimized for high performance inference), an inference runtime software to execute the model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the model(s). When replacing or updating, the software that performs the replacement/updating may maintain user configurations of the inference runtime software and enterprise management software.

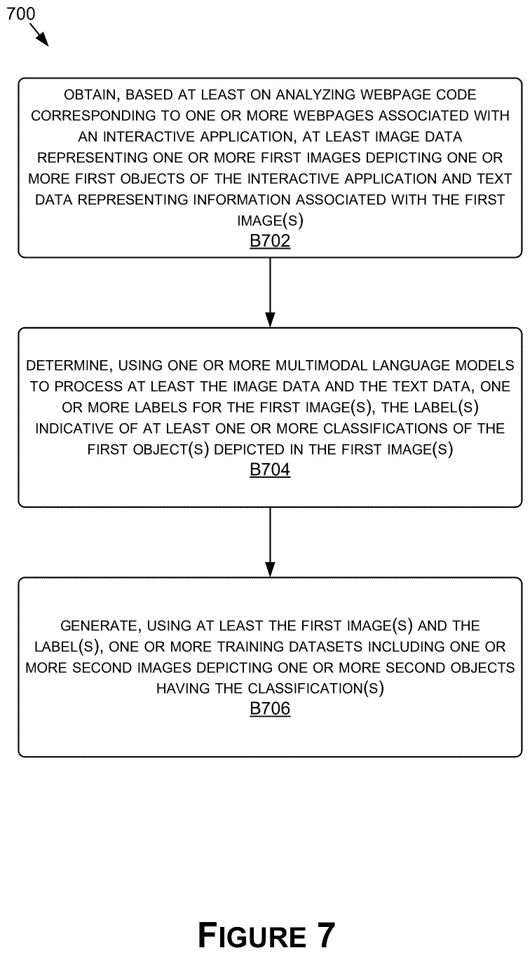

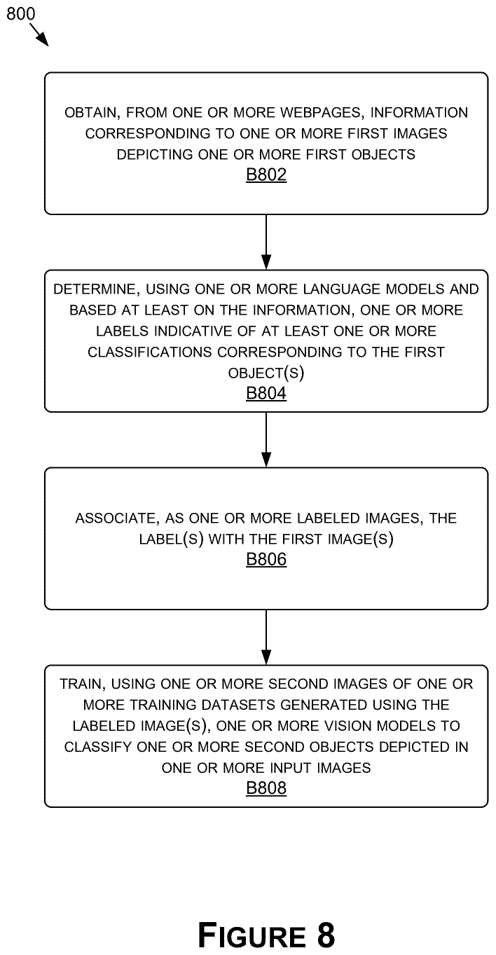

Now referring to FIGS. 7 and 8, each block of method 700 and 800, described herein, comprises a computing process that may be performed using any combination of hardware, firmware, and/or software. For instance, various functions may be carried out using one or more processors executing instructions stored in one or more memories. The methods may also be embodied as computer-usable instructions stored on computer storage media. The methods may be provided by a standalone application, a service or hosted service (standalone or in combination with another hosted service), as a microservice via an application programming interface (API) or a plug-in to another product, to name a few. In addition, methods 700 and 800 are described, by way of example, with respect to the system of FIG. 1. However, these methods may additionally or alternatively be executed by any one system, or any combination of systems, including, but not limited to, those described herein.

FIG. 7 is a flow diagram illustrating an example of a method 700 for using a multimodal language model to automatically label seed images for generating a training dataset, in accordance with some embodiments of the present disclosure. The method 700, at block B702, includes obtaining, based at least on analyzing webpage code corresponding to one or more webpages associated with an interactive application, at least image data representing one or more first images depicting one or more first objects of the interactive application and text data representing information associated with the first image(s). For instance, the crawler 102 may analyze the webpage code corresponding to the webpage(s) 118 to obtain the seed image data 112 including the seed image(s) 114 and the information 116.

The method 700, at block B704, includes determining, using one or more multimodal language models to process at least the image data and the text data, one or more labels for the first image(s), the label(s) indicative of at least one or more classifications (or any other information) of the first object(s) depicted in the first image(s). For instance, the language model(s) 104 may process the seed image data 112 to determine the label(s). In some instances, the systems of the present disclosure may generate the labeled seed image(s) 120 based at least on the language model(s) 104 processing the seed image data 112 and determining the label(s).

The method 700, at block B706, includes generating, using at least the first image(s) and the label(s), one or more training datasets including one or more second images depicting one or more second objects having the classification(s). For instance, the dataset generator 110 may use the labeled seed image(s) 120 to generate the training dataset(s) 126 including, at least, the labeled target image(s) 128.

Referring now to FIG. 8, FIG. 8 is a flow diagram illustrating an example of a method 800 for training one or more vision models to classify objects in an interactive application using one or more automatically generated datasets, in accordance with some embodiments of the present disclosure. The method 800, at block B802, includes obtaining, from one or more webpages, information corresponding to one or more first images depicting one or more first objects. For instance, the crawler 102 may obtain, from the webpage(s) 118, the information 116 corresponding to the seed image(s) 114 depicting the first objects.

The method 800, at block B804, includes determining, using one or more language models (e.g., a multimodal large language model(s)) and based at least on the information, one or more labels indicative of at least one or more classifications corresponding to the first object(s). For example, the system(s) may determine, using the language model(s) 104 and based at least on the information 116, the label(s) indicative of the classification(s) corresponding to the first object(s).

The method 800, at block B806, includes associating, as one or more labeled images, the label(s) with the first image(s). For instance, the system(s) may generate the labeled seed image(s) 120 based at least on associated the label(s) with the seed image(s) 114.

The method 800, at block B808, includes training, using one or more second images of one or more training datasets generated using the labeled image(s), one or more vision models to classify one or more second objects depicted in one or more input images. For example, the training engine 508 may train the model(s) 502 using the training dataset(s) 126 including, at least, the labeled target image(s) 128.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein-may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 9A is a block diagram of an example generative language model system 900 suitable for use in implementing at least some embodiments of the present disclosure. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a SLM, a VLM, a multi-modal LM, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 930 (e.g., LLM/SLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/SLM/VLM/MMLM/etc. with external knowledge, so that answers to specific questions or queries or requests are more relevant—such as in a case where specific knowledge is required. The RAG component 992 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve-using a RAG model performing a vector search in an embedding space, for example-the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history—or at least a summary thereof—and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features-such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use—or capable of accessing or using—plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated -e.g., recursively-for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources-such as the plug-ins/APIs 995.

FIG. 9B is a block diagram of an example implementation in which the generative LM 930 includes a transformer encoder-decoder. For example, assume input text such as “Who discovered gravity” is tokenized (e.g., by the tokenizer 910 of FIG. 9A) into tokens such as words, and each token is encoded (e.g., by the embedding component 920 of FIG. 99A) into a corresponding embedding (e.g., of size 912). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 940 may convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 may generate a first token, and the generation mechanism 955 may apply the generated token as an input during a second pass. The process may repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 may output some decoded (e.g., vector) representation of the input being applied during a particular pass. The classifier 950 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 955 may select or sample a word or token based on a corresponding predicted probability (e.g., select the word with the highest predicted probability) and append it to the output from a previous pass, generating each word or token sequentially. The generation mechanism 955 may repeat the process, triggering successive decoder inputs and corresponding predictions until selecting or sampling a symbol or token that represents the end of the response, at which point, the generation mechanism 955 may output the generated response.

FIG. 9C is a block diagram of an example implementation in which the generative LM 930 includes a decoder-only transformer architecture. For example, the decoder(s) 960 of FIG. 9C may operate similarly as the decoder(s) 945 of FIG. 9B except each of the decoder(s) 960 of FIG. 9C omits the encoder-decoder self-attention layer (since there is no encoder in this implementation). As such, the decoder(s) 960 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 960. As with the decoder(s) 945 of FIG. 9B, each token (e.g., word) may flow through a separate path in the decoder(s) 960, and the decoder(s) 960, a classifier 965, and a generation mechanism 970 may use auto-regression to sequentially generate one token at a time until predicting a symbol or token that represents the end of the response. The classifier 965 and the generation mechanism 970 may operate similarly as the classifier 950 and the generation mechanism 955 of FIG. 9B, with the generation mechanism 970 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may use distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: obtaining, based at least on analyzing webpage code corresponding to one or more webpages associated with an interactive application, at least: image data representing one or more first images depicting one or more first objects of the interactive application; and text data representing information associated with the one or more first images; determining, using one or more multimodal language models to process at least the image data and the text data, one or more labels for the one or more first images, the one or more labels indicative of at least one or more classifications of the one or more first objects depicted in the one or more first images; and generating, using at least the one or more first images and the one or more labels, one or more training datasets including one or more second images depicting one or more second objects having the one or more classifications.
B. The method of paragraph A, further comprising: applying, as input to one or more vision models, the one or more second images included in the one or more training datasets; and updating one or more parameters of the one or more vision models based at least on one or more differences between one or more second labels associated with the one or more second images and one or more predicted classifications of the one or more second objects, the one or more predicted classifications determined using the one or more vision models.
C. The method of any one of paragraphs A-B, wherein the text data corresponds to at least one of: one or more Uniform Resource Locators (URLs) associated with the one or more first images; one or more HyperText Markup Language (HTML) alt text attributes associated with the one or more first images; one or more HTML title attributes associated with the one or more first images; or textual information from the one or more webpages, the textual information referencing the one or more first images.
D. The method of any one of paragraphs A-C, further comprising: obtaining, from second image data representing one or more videos associated with the interactive application, the one or more second images depicting the one or more second objects; determining, based at least on comparing the one or more first images with the one or more second images, that the one or more second objects have the one or more classifications; and associating the one or more labels with the one or more second images.
E. The method of any one of paragraphs A-D, further comprising: comparing the one or more first images and the one or more second images; computing, based at least on the comparing, one or more scores representative of one or more similarities between the one or more first objects and the one or more second objects; and based at least on the one or more scores meeting or exceeding a threshold, associating, with the one or more second images, the one or more labels indicating at least the one or more classifications of the one or more second objects.
F. The method of any one of paragraphs A-E, wherein comparing the one or more first images and the one or more second images comprises: generating one or more segmented versions of the one or more second images; and comparing at least one or more portions of the one or more first images with the one or more segmented versions of the one or more second images.
G. The method of any one of paragraphs A-F, wherein the one or more second images further depict one or more third objects that are distinguishable from the one or more second objects, the one or more third objects having one or more second classifications that are distinguishable from the one or more classifications.
H. A system comprising: one or more processors to: obtain, from one or more network resources, information corresponding to one or more first images depicting one or more first objects; determine, using one or more language models and based at least on the information, one or more labels indicative of at least one or more classifications corresponding to the one or more first objects; associate, as one or more labeled images, the one or more labels with the one or more first images; and train, using one or more second images of one or more training datasets generated using the one or more labeled images, one or more vision models to classify one or more second objects depicted in one or more input images.
I. The system of paragraph H, wherein the one or more language models include one or more multimodal language models and the information includes text data representing, at least: one or more location identifiers associated with the one or more first images; one or more alt text attributes associated with the one or more first images; or webpage text from one or more webpages corresponding to the one or more network resources, the webpage text referencing the one or more first images.
J. The system of any one of paragraphs H-I, wherein the training of the one or more vision models comprises: applying, as one or more training inputs to the one or more vision models, one or more second images included in the one or more training datasets, the one or more second images depicting one or more third objects having the one or more classifications; receiving, from the one or more vision models responsive to the one or more training inputs, one or more predicted classifications of the one or more third objects; and updating one or more parameters of the one or more vision models based at least on one or more differences between the one or more classifications and one or more predicted classifications.
K. The system of any one of paragraphs H-J, wherein the one or more processors further to: determine, using the one or more language models and based at least on the information, one or more second labels indicative of one or more second classifications corresponding to one or more third objects depicted in the one or more first images; and associate the one or more second labels with the one or more first images, wherein the one or more third objects are distinguishable from the one or more first objects and the one or more second classifications are distinguishable from the one or more classifications.
L. The system of any one of paragraphs H-K, the one or more processors further to: obtain the one or more second images from image data representing one or more videos of an interactive application; compute, based at least on a comparison of the one or more first images and the one or more second images, one or more scores indicative of one or more similarities between the one or more first objects and one or more third objects depicted in the one or more second images; and based at least on the one or more scores meeting or exceeding a threshold, associating, with the one or more second images, at least the one or more labels.
M. The system of any one of paragraphs H-L, wherein the information comprises at least one of: one or more Uniform Resource Locators (URLs) associated with the one or more first images; one or more HyperText Markup Language (HTML) alt text attributes associated with the one or more first images; or one or more HTML title attributes associated with the one or more first images.
N. The system of any one of paragraphs H-M, the one or more processors further to: generate one or more segmented versions of the one or more second images; determine, using the one or more segmented versions, that one or more differences between one or more first physical attributes of the one or more first objects and one or more second physical attributes of one or more third objects depicted in the one or more second images are less than a threshold; and based at least on the one or more differences being less than the threshold, associate the one or more labels with the one or more second images.
O. The system of any one of paragraphs H-N, the one or more processors further to: detect, using one or more Optical Character Recognition (OCR) models, textual information depicted in the one or more second images; and associate, with the one or more second images, one or more second labels indicating one or more attributes associated with the textual information, the one or more attributes including at least one of: a classification of the textual information; a semantic meaning associated with the textual information; a confidence score associated with the textual information; or a contextual relationship between the textual information and one or more third objects depicted in the one or more second images.
P. The system of any one of paragraphs H-O, wherein the one or more second images depict one or more first scenes associated with a first instance of a gaming application and the one or more input images depict one or more second scenes associated with a second instance of the gaming application.
Q. The system of any one of paragraphs H-P, wherein the one or more second images depict one or more third objects having one or more second classifications that are distinguishable from the one or more classifications.
R. The system of any one of paragraphs H-Q, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-modal language models; a system implementing one or more large language models (LLMs); a system implementing one or more vision language models (VLMs); a system implementing one or more small language models (SLMs); a system for generating synthetic data; a system for generating synthetic data using AI; a system incorporating one or more virtual machines (VMs); a system implemented at least partially in a data center; or a system implemented at least partially using cloud computing resources.
S. One or more processors comprising: processing circuitry to classify, using one or more vision models, one or more objects depicted in one or more image frames associated with an interactive application, wherein the one or more vision models are trained using one or more training datasets that are generated, at least, by: obtaining, from one or more network resources, information corresponding to one or more first images depicting the one or more objects; associating, based at least on one or more language models processing the information, one or more labels with the one or more first images, the one or more labels indicative of at least one or more classifications associated with the one or more objects; and appending, to the one or more training datasets and based at least on the one or more first images and the one or more labels, one or more second images depicting one or more second objects having the one or more classifications.
T. The one or more processors of paragraph S, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-modal language models; a system implementing one or more large language models (LLMs); a system implementing one or more vision language models (VLMs); a system implementing one or more small language models (SLMs); a system for generating synthetic data; a system for generating synthetic data using AI; a system incorporating one or more virtual machines (VMs); a system implemented at least partially in a data center; or a system implemented at least partially using cloud computing resources.

What is claimed is:

1. A method comprising:
obtaining, based at least on analyzing webpage code corresponding to one or more webpages associated with an interactive application, at least:
image data representing one or more first images depicting one or more first objects of the interactive application; and
text data representing information associated with the one or more first images;
determining, using one or more multimodal language models to process at least the image data and the text data, one or more labels for the one or more first images, the one or more labels indicative of at least one or more classifications of the one or more first objects depicted in the one or more first images; and
generating, using at least the one or more first images and the one or more labels, one or more training datasets including one or more second images depicting one or more second objects having the one or more classifications.

2. The method of claim 1, further comprising:
applying, as input to one or more vision models, the one or more second images included in the one or more training datasets; and
updating one or more parameters of the one or more vision models based at least on one or more differences between one or more second labels associated with the one or more second images and one or more predicted classifications of the one or more second objects, the one or more predicted classifications determined using the one or more vision models.

3. The method of claim 1, wherein the text data corresponds to at least one of:
one or more Uniform Resource Locators (URLs) associated with the one or more first images;
one or more HyperText Markup Language (HTML) alt text attributes associated with the one or more first images;
one or more HTML title attributes associated with the one or more first images; or
textual information from the one or more webpages, the textual information referencing the one or more first images.

4. The method of claim 1, further comprising:
obtaining, from second image data representing one or more videos associated with the interactive application, the one or more second images depicting the one or more second objects;
determining, based at least on comparing the one or more first images with the one or more second images, that the one or more second objects have the one or more classifications; and
associating the one or more labels with the one or more second images.

5. The method of claim 1, further comprising:
comparing the one or more first images and the one or more second images;
computing, based at least on the comparing, one or more scores representative of one or more similarities between the one or more first objects and the one or more second objects; and
based at least on the one or more scores meeting or exceeding a threshold, associating, with the one or more second images, the one or more labels indicating at least the one or more classifications of the one or more second objects.

6. The method of claim 5, wherein comparing the one or more first images and the one or more second images comprises:
generating one or more segmented versions of the one or more second images; and
comparing at least one or more portions of the one the one or more first images with the one or more segmented versions of the one or more second images.

7. The method of claim 1, wherein the one or more second images further depict one or more third objects that are distinguishable from the one or more second objects, the one or more third objects having one or more second classifications that are distinguishable from the one or more classifications.

8. A system comprising:
one or more processors to:
obtain, from one or more network resources, information corresponding to one or more first images depicting one or more first objects;
determine, using one or more language models and based at least on the information, one or more labels indicative of at least one or more classifications corresponding to the one or more first objects;
associate, as one or more labeled images, the one or more labels with the one or more first images; and
train, using one or more second images of one or more training datasets generated using the one or more labeled images, one or more vision models to classify one or more second objects depicted in one or more input images.

9. The system of claim 8, wherein the one or more language models include one or more multimodal language models and the information includes text data representing, at least:
one or more location identifiers associated with the one or more first images;
one or more alt text attributes associated with the one or more first images; or
webpage text from one or more webpages corresponding to the one or more
network resources, the webpage text referencing the one or more first images.

10. The system of claim 8, wherein the training of the one or more vision models comprises:
applying, as one or more training inputs to the one or more vision models, one or more second images included in the one or more training datasets, the one or more second images depicting one or more third objects having the one or more classifications;
receiving, from the one or more vision models responsive to the one or more training inputs, one or more predicted classifications of the one or more third objects; and
updating one or more parameters of the one or more vision models based at least on one or more differences between the one or more classifications and one or more predicted classifications.

11. The system of claim 8, the one or more processors further to:
determine, using the one or more language models and based at least on the information, one or more second labels indicative of one or more second classifications corresponding to one or more third objects depicted in the one or more first images; and
associate the one or more second labels with the one or more first images,
wherein the one or more third objects are distinguishable from the one or more first objects and the one or more second classifications are distinguishable from the one or more classifications.

12. The system of claim 8, the one or more processors further to:
obtain the one or more second images from image data representing one or more videos of an interactive application;
compute, based at least on a comparison of the one or more first images and the one or more second images, one or more scores indicative of one or more similarities between the one or more first objects and one or more third objects depicted in the one or more second images; and
based at least on the one or more scores meeting or exceeding a threshold, associating, with the one or more second images, at least the one or more labels.

13. The system of claim 8, wherein the information comprises at least one of:
one or more Uniform Resource Locators (URLs) associated with the one or more first images;
one or more HyperText Markup Language (HTML) alt text attributes associated with the one or more first images; or
one or more HTML title attributes associated with the one or more first images.

14. The system of claim 8, the one or more processors further to:
generate one or more segmented versions of the one or more second images;
determine, using the one or more segmented versions, that one or more differences between one or more first physical attributes of the one or more first objects and one or more second physical attributes of one or more third objects depicted in the one or more second images are less than a threshold; and
based at least on the one or more differences being less than the threshold, associate the one or more labels with the one or more second images.

15. The system of claim 8, the one or more processors further to:
detect, using one or more Optical Character Recognition (OCR) models, textual information depicted in the one or more second images; and
associate, with the one or more second images, one or more second labels indicating one or more attributes associated with the textual information, the one or more attributes including at least one of:
a classification of the textual information;
a semantic meaning associated with the textual information;
a confidence score associated with the textual information; or
a contextual relationship between the textual information and one or more third objects depicted in the one or more second images.

16. The system of claim 8, wherein the one or more second images depict one or more first scenes associated with a first instance of a gaming application and the one or more input images depict one or more second scenes associated with a second instance of the gaming application.

17. The system of claim 8, wherein the one or more second images depict one or more third objects having one or more second classifications that are distinguishable from the one or more classifications.

18. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system implementing one or more small language models (SLMs);
a system for generating synthetic data;
a system for generating synthetic data using AI;
a system incorporating one or more virtual machines (VMs);
a system implemented at least partially in a data center; or
a system implemented at least partially using cloud computing resources.

19. One or more processors comprising:
processing circuitry to classify, using one or more vision models, one or more objects depicted in one or more image frames associated with an interactive application, wherein the one or more vision models are trained using one or more training datasets that are generated, at least, by:
obtaining, from one or more network resources, information corresponding to one or more first images depicting the one or more objects;
associating, based at least on one or more language models processing the information, one or more labels with the one or more first images, the one or more labels indicative of at least one or more classifications associated with the one or more objects; and
appending, to the one or more training datasets and based at least on the one or more first images and the one or more labels, one or more second images depicting one or more second objects having the one or more classifications.

20. The one or more processors of claim 19, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system implementing one or more small language models (SLMs);
a system for generating synthetic data;
a system for generating synthetic data using AI;
a system incorporating one or more virtual machines (VMs);
a system implemented at least partially in a data center; or
a system implemented at least partially using cloud computing resources.
